(19) United States
(12) Patent Application Publication
(10) Pub. No.: US 2011/0063551 A1
(43) Pub. Date: Mar. 17, 2011

(54) LIQUID CRYSTAL DISPLAY DEVICE

(75) Inventors: Jae-Kyung GO, Yongin-City (KR); Sam-Ho IHM, Yongin-city (KR)

(73) Assignee: Samsung Mobile Display Co., Ltd., Yongin-city (KR)

(21) Appl. No.: 12/727,071

(22) Filed: Mar. 18, 2010

(30) Foreign Application Priority Data
Sep. 17, 2009 (KR) 10-2009-0087986

(51) Int. Cl. G02F 1/1335

(52) U.S. Cl. 349/114

(57) ABSTRACT

In a transflective type fringe field switching liquid crystal display device, the display device may comprise wires including a plurality of gate wirings and a plurality of data wirings providing electric signals to a plurality of pixel regions, wherein each of the pixel regions is partitioned into a transmission region and a reflection region and at least one first transparent electrode having a flat shape and formed in each of the pixel regions. The device may further include a plurality of second transparent electrodes formed over the first transparent electrode, a reflection plate formed on the first transparent electrode located in the reflection region; and a plurality of embossings formed on the reflection plate, wherein the center of each embossing is formed only on the reflection plate.

### CROSS-REFERENCE TO RELATED APPLICATIONS

This application claims priority to and the benefit of Korean Patent Application No. 10-2009-0087986, filed on Sep. 17, 2009, in the Korean Intellectual Property Office, the entire content of which is incorporated herein by reference.

This application relates to U.S. patent application entitled “Liquid Crystal Display Device” (Attorney docket: SMDSHN.150AUS), which is concurrently filed as this application and incorporated herein by reference in its entirety.

### BACKGROUND

1. Field

Non-limiting example embodiments relate to a liquid crystal display device, and more particularly, to a transflective type fringe field switching liquid crystal display device.

2. Discussion of the Related Technology

The driving principle of a liquid crystal display device uses the optical anisotropy and polarization characteristics of liquid crystal. The liquid crystal is thin and long to have directionality in arrangement of molecules so that the direction of the molecule arrangement may be controlled by artificially applying electric field.

Therefore, when the direction of the molecule arrangement is optionally controlled, the molecule arrangement of the liquid crystal is changed and light is refracted in the direction of the molecule arrangement of the liquid crystal by the optical anisotropy, making it possible to display an image.

### SUMMARY

Non-limiting example embodiments of the present invention provide a transflective type fringe field switching liquid crystal display device. The liquid crystal display device includes: a first transparent electrode that is partitioned for each pixel, in a flat shape; a second transparent electrode that is formed in a plurality of stripes shape on the first transparent electrodes; and a reflection plate that is formed on the first transparent electrode in the region corresponding to the reflection region of the each pixel, and positioning the center of each embossing formed on the reflection plate in the space between the second transparent electrodes arrange in the stripe shape, thereby implementing improved reflectance.

Non-limiting example embodiments of the present invention provide a liquid crystal display device. The liquid crystal display device comprises: wirings including gate wirings and data wirings proving electric signals to a pixel region partitioned into a transmission region and a reflection region; a first transparent electrode in a flat shape that is formed in the each pixel region; a second transparent electrode that is formed on the first transparent electrode in a plurality of stripes shape; and a reflection plate that is provided with a plurality of embossings and is formed on the first transparent electrode located in the reflection region, wherein the center of each embossing formed on the reflection plate is located in the space between the second transparent electrodes arrange in the stripe shape.

Herein, the first transparent electrode may be a pixel electrode and the second transparent electrode may be a common electrode, and the embossings may be implemented by depositing the reflection plate on the first transparent electrode on which a plurality of embossing pattern is formed.

Moreover, the pattern of each second transparent electrode arranged in the stripe shape may be slantly formed by extending the ends of the embossing.

Furthermore, embossings arranged in odd columns and embossings arranged in even columns, among the plurality of embossings, may be formed on the crossed positions, the sizes thereof may be different, and the size of the embossings arranged in odd columns may be formed to be relatively smaller than the size of the embossings arranged in even columns.

Non-limiting example embodiments of the present invention provide a liquid crystal display device. The liquid crystal display device comprises: wirings including a plurality of gate wirings and a plurality of data wirings providing electric signals to a plurality of pixel regions, wherein each of the pixel regions is partitioned into a transmission region and a reflection region; at least one first transparent electrode having a flat shape and formed in each of the pixel regions; a plurality of second transparent electrodes formed over the first transparent electrode; a reflection plate formed on the first transparent electrode located in the reflection region; and a plurality of embossings formed on the reflection plate, wherein the center of each embossing is formed only on the reflection plate.

In the above device, the first transparent electrode may be a pixel electrode and each of the second transparent electrodes may be a common electrode. In the above device, the first transparent electrode may comprise a raised portion corresponding to one of the embossings. In the above device, the second transparent electrodes may be arranged in a stripe shape pattern, wherein each of the second transparent electrodes may comprise at least one slanted portion and at least one non-slanted portion, and wherein the slanted portions may be located directly above the embossings.

In the above device, the embossings may comprise first embossings arranged in odd columns and second embossings arranged in even columns, and wherein the sizes of at least one of the first embossings and at least one of the second embossings may be different. In the above device, the size of the first embossings may be relatively smaller than the size of the second embossings. The above device may further comprise a protective layer interposed between the first and second transparent electrodes.

In the above device, the protective layer may comprise at least one raised portion corresponding to at least one of the embossings. In the above device, the raised portion of the protective layer may be located directly above the at least one embossing. In the above device, the first transparent electrode may comprise a raised portion corresponding to at least one of the embossings. In the above device, the raised portion of the first transparent electrode may be located directly below the at least one embossing.

Non-limiting example embodiments of the present invention provide a liquid crystal display device. The liquid crystal display device comprises wirings including a plurality of gate wirings and a plurality of data wirings providing electric signals to a plurality of pixel regions, wherein each of the pixel regions comprises a transmission region and a reflection region; at least one first transparent electrode formed in each of the pixel regions, wherein a first portion of the first transparent electrode is located in the transmission region, and wherein a second portion of the first transparent electrode is located in the reflection region; a reflection plate formed on the second portion of the first transparent electrode; and a plurality of embossings formed on the reflection plate, wherein the center of each embossing is formed only on the reflection plate.

The above device may further comprise a plurality of second transparent electrodes formed over the first transparent electrode. In the above device, the first transparent electrode may comprise a raised portion corresponding to at least one of the embossings. In the above device, the raised portion of the first transparent electrode may be located directly below the at least one embossing.

The above device may further comprise a protective layer interposed between the first and second transparent electrodes, wherein the protective layer comprises at least one raised portion corresponding to the at least one embossing. In the above device, the raised portion of the protective layer may be located directly above the at least one embossing. In the above device, each of the second transparent electrodes may comprise a raised portion corresponding to at least one of the embossings, and wherein the raised portions of the first transparent electrode, the protective layer and each of the second transparent electrodes may be substantially aligned with the at least one embossing.

Non-limiting example embodiments of the present invention provide a liquid crystal display device. The liquid crystal display device comprises: wirings including a plurality of gate wirings and a plurality of data wirings providing electric signals to a plurality of pixel regions, wherein each of the pixel regions comprises a transmission region and a reflection region; a plurality of first transparent electrodes formed in each of the pixel regions, wherein a first portion of the first transparent electrodes is located in the transmission region, and wherein a second portion of the first transparent electrodes is located in the reflection region; and a reflection plate formed on the second portion of the first transparent electrode, wherein the reflection plate comprises a plurality of raised portions, and wherein the center of each raised portion is formed only on the reflection plate.

In the above device, the first transparent electrode may comprise a plurality of raised portions corresponding to and directly above the raised portions of the reflection plate.

### BRIEF DESCRIPTION OF THE DRAWINGS

The accompanying drawings, together with the specification illustrate non-limiting example embodiments of the present invention.

FIG. 1 is a plan view illustrating one region of an array substrate of a liquid crystal display device according to a non-limiting example embodiment of the present invention.

FIG. 2 is a cross-sectional view of a transmission region including the thin film transistor of FIG. 1.

FIG. 3 is a cross-sectional view of a specific portion A-A′ of the reflection region of FIG. 1.

FIG. 4 is an enlarged plan view illustrating the reflection region of FIG. 1 in more detail.

### DETAILED DESCRIPTION

Generally, the liquid crystal display device may include a color filter substrate on which a common electrode may be formed, an array substrate on which a pixel electrode may be formed, and liquid crystal filled between the two substrates. In such a liquid crystal display device, the liquid crystal may be driven by the electric field applied upward and downward between the common electrode and the pixel electrode.

However, the liquid crystal driving by the electric field applied upward and downward may have a disadvantage that viewing angle characteristics may be not excellent. In order to solve the disadvantage, a horizontal electrical field type liquid crystal display device has been proposed. In the horizontal electrical field type liquid crystal display device, a pixel electrode and a common electrode spaced from each other may be formed on an array substrate to form a horizontal electrical field on the substrate surface, the horizontal electrical field being in substantially parallel. However, the horizontal electrical field type liquid crystal display device may have a disadvantage that brightness may be degraded.

In order to solve the disadvantage of the horizontal electrical field type liquid crystal display device as described above, a fringe field switching (FFS) type liquid crystal display device has been proposed.

In the FFS type liquid crystal display device, a common electrode in a flat shape may be formed on a substrate and a plurality of pixel electrodes may be formed on the common electrode for each pixel. The respective ends of the pixel electrodes may be coupled into one through a coupling part for each pixel.

In the FFS type liquid crystal display device, liquid crystal may be driven by the electrical field generated between the lower common electrode and the upper pixel electrodes. In particular, the common electrode and the pixel electrodes are may be very closely located to generate a strong electrical field so that the liquid crystal on the upper portion of the pixel electrodes may be also normally operated. This leads to effects that a transmission region may be expanded, thereby increasing brightness.

The liquid crystal display device may be divided into a reflection type liquid crystal display device and a transmission type liquid crystal display device according to light source to be used.

The reflection type liquid crystal display device receives natural light, as a light source, and reflects it to have an advantage that power consumption may be small, but may be affected by an external environment to have a disadvantage that an image having a high brightness cannot be obtained.

The transmission type liquid crystal display device receives artificial light from a light generating unit provided inside the liquid crystal display device, as a light source, and transmits it. The display device may have an advantage that an image having a high brightness can be obtained but may have a disadvantage that power consumption for driving the light generating unit may be large.

Therefore, in order to manufacture a liquid crystal display device that may have a low power consumption simultaneously with obtaining an image having a high brightness, a transflective type liquid crystal display panel that supplements the respective disadvantages of the reflection type and the transmission type liquid crystal display panels has been proposed.

In the transflective type liquid crystal display panel, one pixel region may be divided into a reflection region and a transmission region. In the transmission region, a predetermined brightness may be guaranteed by the light provided from the backlight assembly to the liquid crystal display panel. However, in the reflection region reflectance may be changed according to the external light quantity or the path of light to be incident to degrade brightness in the reflection region, having a problem that the display quality of the liquid crystal display panel may be degraded.

In order to solve the problem, the reflection characteristics may be improved by forming embossing on a reflection plate formed in the reflection region and the reflection characteristics may be determined according to the size, height, and disposition shape of the embossing.

In the related art, the embossing has been implemented to be randomly formed or to be combined by mixing embossing with different size. However, a disadvantage may arise in that the reflection characteristics of the horizontal electrical field type or the FFS type liquid crystal display device may not be properly implemented based on the embossing design in the related art.

One non-limiting example embodiment may be a liquid crystal display device having an embossing design to meet the characteristics of the horizontal electrical field type in which electrical field may be horizontally applied or the characteristics of the fringe field switching type.

In the following detailed description, only certain non-limiting example embodiments of the present invention have been shown and described, simply by way of illustration. As those skilled in the art would realize, the described non-limiting example embodiments may be modified in various different ways, all without departing from the spirit or scope of the present invention. Accordingly, the drawings and description may be to be regarded as illustrative in nature and not restrictive. In addition, when an element may be referred to as being “on” another element, it can be directly on another element or be indirectly on another element with one or more intervening elements interposed therebetween. Also, when an element may be referred to as being “connected to” another element, it can be directly connected to another element or be indirectly connected to another element with one or more intervening elements interposed therebetween. Hereinafter, like reference numerals refer to like elements.

Hereinafter, non-limiting example embodiments of the present invention will be described in detail with reference to the accompanying drawings.

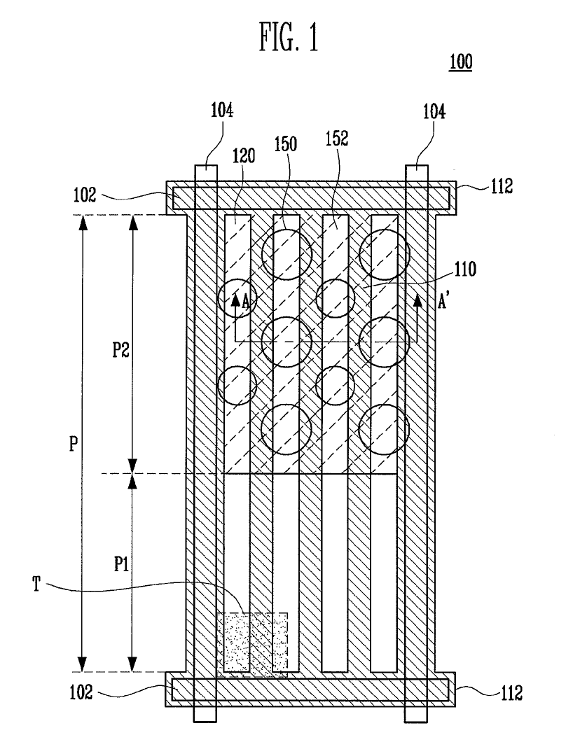

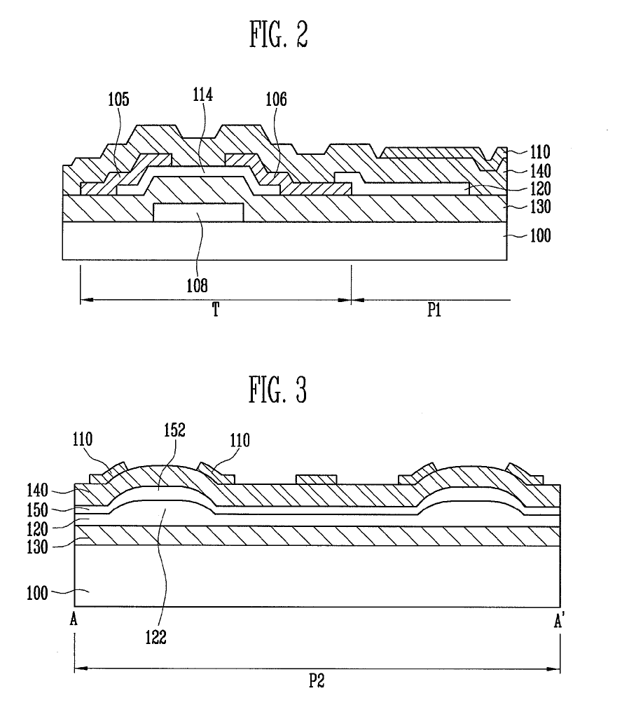

FIG. 1 is a plan view illustrating one region of an array substrate of a liquid crystal display device according to a non-limiting example embodiment of the present invention, and FIG. 2 is a cross-sectional view of a transmission region including the thin film transistor of FIG. 1.

In one non-limiting example embodiment, as shown in FIG. 1, the liquid crystal display device may be a transflective type FFS liquid crystal display device. In this non-limiting example embodiment, the liquid crystal display device may comprises wires include gate wirings 102 and data wirings 104 providing electric signals to a pixel region P. The gate wirings 102 extend in a first direction and the data wirings 104 extend in a second direction. The gate wirings 102 and the data wirings 104 may intersect with each other to define the pixel region P. However, the pixel region P may not be defined by the gate wirings 102 and the data wirings 104. For example, the gate wirings 102 and/or the data wirings 104 may extend through the pixel region P. The gate wirings 102 and the data wirings 10 may be located on a substrate 100. Further, the pixel region P may be partitioned into a transmission region P1 and a reflection region P2.

A thin film transistor T may be located on the position where the gate wiring 102 may be intersected with the data wiring 104. An exemplary configuration of the thin film transistor T and the transmission region P may be shown in FIG. 2.

In this non-limiting example embodiment, the thin film transistor T may include a gate electrode 108 coupled to the gate wiring 102 formed on the substrate 100, a semiconductor layer 114 located on the upper portion of the gate electrode 108, a source electrode 105 located on the upper portion of the semiconductor layer 114 and contacting the data wiring 104, and a drain electrode 106 spaced from the source electrode 105.

A gate dielectric layer 130 may be formed between the gate electrode 108 and the semiconductor layer 114, and a protecting layer 140 may be formed between a first transparent electrode 120 and a second transparent electrode 110.

In one non-limiting example embodiment, as shown in FIGS. 1 and 2, a first transparent electrode 120 in a substantially flat shape may be formed in the transmission region P1 to be contacted electrically to the drain electrode 160. In this non-limiting example embodiment, the first transparent electrode 120 may operate as a pixel electrode.

In one non-limiting example embodiment, the second transparent electrode 110 may extend in a second direction and being implemented in a plurality of substantial stripe shape spaced from each other, and may be formed on the upper portion of the first transparent electrode 120. In this non-limiting example embodiment, the second transparent electrode 110 may operate as a common electrode. The ends of the second transparent electrode 110 may be coupled to each other through a coupling part 112 and a common voltage may be applied to the second transparent electrode 110.

In one non-limiting example embodiment, the liquid crystal of the liquid crystal display device may be driven by the electrical field generated between the first transparent electrode 120, formed on the lower portion as the pixel electrode, and the second transparent electrode 110 formed on the upper portion of the first transparent electrode 120 as the common electrode.

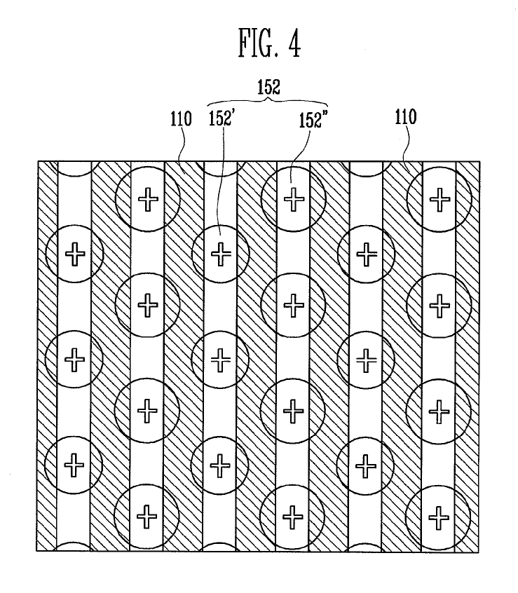

FIG. 3 is a cross-sectional view of a specific portion A-A′ of the reflection region of FIG. 1, and FIG. 4 is an enlarged plan view illustrating the reflection region of FIG. 1 in more detail.

In one non-limiting example embodiment, as shown in FIG. 3, for the pixel region P of each pixel, a portion thereof may be implemented as the transmission region P1 as shown in FIG. 2, and a portion of others thereof may be implemented as a reflection region P2. In the case of the reflection region P2, a reflection plate 150 may be formed between the first transparent electrode 120 and the protecting layer 140.

The reflection plate 150, which serves to reflect light incident on the outside, may be formed using metal having excellent reflectance characteristics, such as aluminum (Al), copper (Cu), chrome (Cr), etc.

A plurality of embossings 152 may be formed on the reflection plate 150, wherein such embossings serve to widen viewing angle by sectionally changing the reflection angle of the external natural light when the external natural light may be used as a light source.

The embossing may be formed in various methods. In one non-limiting example embodiment, a plurality of embossing patterns 122 may be formed on the first transparent electrode 120 formed in the reflection region P2 as shown in FIG. 3, thereby implementing the plurality of embossings 152 on the reflection plate 150 deposited on the first transparent electrode 120.

In the reflection region P2 of each pixel, the first transparent electrode 120 on which the plurality of embossing patterns 122 may be formed may be formed integrally with the first transparent electrode 120 formed in the transmission region P1 of FIG. 2 on the substrate 100.

A dielectric layer including a gate dielectric layer 130, etc., may be formed between the substrate 100 and the first transparent electrode 120, wherein the dielectric layer may be generally formed using inorganic dielectric material including, but not limited to, silicon nitride (SiNX) and silicon oxide (SiO₂).

The reflection plate 150 may be formed on the first transparent electrode 120 located in the reflection region P2 so that a plurality of embossings 152 may be implemented on the reflection plate 150 to correspond to the embossing pattern 122.

The protecting layer 140 may be formed on the upper portion of the reflection plate 150, and the second transparent electrode 110 may be formed on the protecting layer 140 as a common electrode.

In one non-limiting example embodiment, the protecting layer 140 may be formed using inorganic dielectric material including, but not limited to, silicon nitride (SiNX) and silicon oxide (SiO₂) or organic dielectric material including, but not limited to, benzocyclobutene (BCB) and acrylic resin.

The first transparent electrode 120 and the second transparent electrode 110 may include, but not limited to, indium-tin-oxide (ITO) and indium-zinc-oxide (IZO).

In one non-limiting example embodiment, the second transparent electrodes 110 may be spaced having a predetermined interval in a stripe shape on the positions overlapped with the first transparent electrodes 120, in the same manner as in the transmission region P1.

In one non-limiting example embodiment, the center of each of the plurality of embossings 152 may be located only in the space between the second transparent electrodes 110 arranged in a substantial stripe shape.

The second transparent electrode 110 may not be formed on the embossing 152 but may be slantly arranged by extending the ends of the embossing 152, as shown in FIG. 3.

In one non-limiting example embodiment, the second transparent electrodes 110 arranged in a substantial stripe shape may operate as a factor to determine the reflection characteristics according to the line width thereof and the interval between respective patterns. In one non-limiting example embodiment, the second transparent electrode pattern 110 in the substantial stripe shape may be located on the ends of the respective embossings 152, making it possible to increase reflectance.

Furthermore, in one non-limiting example embodiment, as shown in FIG. 4, when arranging the plurality of embossings 152, the sizes of the plurality of embossings may be arranged to be different for each column, thereby improving the density of embossing per area.

In one non-limiting example embodiment, as shown in FIG. 4, all the centers of the respective embossings 152 may be located only in the space between the second transparent electrodes 110 arranged in a stripe shape. In one non-limiting example embodiment, the embossings 152′ arranged in odd columns and the embossings 152″ arranged in even columns may be formed on the crossed positions and the sizes thereof may be substantially different.

For example, in the non-limiting example embodiment of FIG. 4, the size of the embossings 152′ arranged in odd columns may be smaller than the size of the embossings 152″ arranged in even columns. In this non-limiting example embodiment, the density of the embossings per area can be improved by the arrangement of embossings 152 as above, the arrangement of embossings 152 consequently being a factor to improve reflectance. In another non-limiting example embodiment, the size of the embossings 152′ arranged in odd columns may be substantial equal to or relatively greater than the size of the embossings 152″ arranged in even columns.

According to at least one non-limiting example embodiment, the center of the plurality of embossings formed in the reflection region of each pixel may be located only between the second transparent electrodes arranged in a substantial stripe pattern, making it possible to improve reflectance. Furthermore, the sizes of the plurality of embossings may be substantially different for each column, making it possible to improve the density of embossings per area.

While the present invention has been described in connection with certain non-limiting example embodiments, it may be to be understood that the invention may be not limited to the disclosed non-limiting example embodiments, but, on the contrary, may be intended to cover various modifications and equivalent arrangements included within the spirit and scope of the appended claims, and equivalents thereof.

What is claimed is:

1. A liquid crystal display device comprising:
wires including a plurality of gate wirings and a plurality of data wirings providing electric signals to a plurality of pixel regions, wherein each of the pixel regions is partitioned into a transmission region and a reflection region;
at least one first transparent electrode having a flat shape and formed in each of the pixel regions;
a plurality of second transparent electrodes formed over the first transparent electrode;
a reflection plate formed on the first transparent electrode located in the reflection region; and
a plurality of embossings formed on the reflection plate, wherein the center of each embossing is formed only on the reflection plate.

2. The liquid crystal display device as claimed in claim 1, wherein the first transparent electrode is a pixel electrode and each of the second transparent electrodes is a common electrode.

3. The liquid crystal display device as claimed in claim 1, wherein the first transparent electrode comprises a raised portion corresponding to one of the embossings.

4. The liquid crystal display device as claimed in claim 1, wherein the second transparent electrodes are arranged in a substantial stripe shape pattern, wherein each of the second transparent electrodes comprises at least one slanted portion and at least one non-slanted portion, and wherein the slanted portions are located directly above the embossings.

5. The liquid crystal display device as claimed in claim 1, wherein the embossings comprise first embossings arranged in odd columns and second embossings arranged in even columns, and wherein the sizes of at least one of the first embossings and at least one of the second embossings are different.

6. The liquid crystal display device as claimed in claim 5, wherein the size of the first embossings is relatively smaller than the size of the second embossings.

7. The liquid crystal display device as claimed in claim 1, further comprising a protective layer interposed between the first and second transparent electrodes.

8. The liquid crystal display device as claimed in claim 7, wherein the protective layer comprises at least one raised portion corresponding to at least one of the embossings.

9. The liquid crystal display device as claimed in claim 8, wherein the raised portion of the protective layer is located directly above the at least one embossing.

10. The liquid crystal display device as claimed in claim 1, wherein the first transparent electrode comprises a raised portion corresponding to at least one of the embossings.

11. The liquid crystal display device as claimed in claim 10, wherein the raised portion of the first transparent electrode is located directly below the at least one embossing.

12. A liquid crystal display device comprising:
wirings including a plurality of gate wirings and a plurality of data wirings providing electric signals to a plurality of pixel regions, wherein each of the pixel regions comprises a transmission region and a reflection region;
at least one first transparent electrode formed in each of the pixel regions, wherein a first portion of the first transparent electrode is located in the transmission region, and wherein a second portion of the first transparent electrode is located in the reflection region;
a reflection plate formed on the second portion of the first transparent electrode; and
a plurality of embossings formed on the reflection plate, wherein the center of each embossing is formed only on the reflection plate.

13. The liquid crystal display device as claimed in claim 12, further comprising a plurality of second transparent electrodes formed over the first transparent electrode.

14. The liquid crystal display device as claimed in claim 13 wherein the first transparent electrode comprises a raised portion corresponding to at least one of the embossings.

15. The liquid crystal display device as claimed in claim 14, wherein the raised portion of the first transparent electrode is located directly below the at least one embossing.

16. The liquid crystal display device as claimed in claim 15, further comprising a protective layer interposed between the first and second transparent electrodes, wherein the protective layer comprises at least one raised portion corresponding to the at least one embossing.

17. The liquid crystal display device as claimed in claim 16, wherein the raised portion of the protective layer is located directly above the at least one embossing.

18. The liquid crystal display device as claimed in claim 17, wherein each of the second transparent electrodes comprises a raised portion corresponding to at least one of the embossings, and wherein the raised portions of the first transparent electrode, the protective layer and each of the second transparent electrodes are substantially aligned with the at least one embossing.

19. A liquid crystal display device comprising:
wirings including a plurality of gate wirings and a plurality of data wirings providing electric signals to a plurality of pixel regions, wherein each of the pixel regions comprises a transmission region and a reflection region;
a plurality of first transparent electrodes formed in each of the pixel regions, wherein a first portion of the first transparent electrodes is located in the transmission region, and wherein a second portion of the first transparent electrodes is located in the reflection region; and
a reflection plate formed on the second portion of the first transparent electrode, wherein the reflection plate comprises a plurality of raised portions, and wherein the center of each raised portion is formed only on the reflection plate.

20. The liquid crystal display device as claimed in claim 19, wherein the first transparent electrode comprises a plurality of raised portions corresponding to and directly above the raised portions of the reflection plate.
